(19) United States
(12) Patent Application Publication
(10) Pub. No.: US 2019/0194916 A1
(43) Pub. Date: Jun. 27, 2019

(54) DECK-MOUNT THERMOSTATIC BATHTUB FAUCET

(71) Applicant: NCIP INC., Taipei (TW)

(72) Inventor: Jeffery Tzeng, Taiwan (TW)

(21) Appl. No.: 15/853,684

(22) Filed: Dec. 22, 2017

(51) Int. Cl. E03C 1/04; F16K 11/00; G05D 23/13

(52) U.S. Cl. CPC E03C 1/041; E03C 2201/30; G05D 23/1306; F16K 19/006

(57) ABSTRACT

The present application provides a deck-mount thermostatic bathtub faucet, including: a thermostatic valve, installed on a deck and connected with a hot water inlet, a cold water inlet and a mixed water outlet, hot water from the hot water inlet and cold water from the cold water inlet mixed in the thermostatic valve to a certain temperature and flowing out of the mixed water outlet; and a diverter valve, installed on a deck and connected with the mixed water outlet, the diverter valve being provided with a first outlet pipe connecting with a faucet which is installed on a deck and a second outlet pipe connecting with a shower, the mixed water from the mixed water outlet into the diverter valve flowing into a faucet or a shower after being controlled by the diverter valve.

### BACKGROUND OF THE INVENTION

### Field of the Invention

The present application generally relates to water faucets and, more particularly, relates to a deck-mount thermostatic bathtub faucet.

### Description of the Related Art

At present, a deck-mount thermostatic bathtub faucet in the United States market is required to install a temperature control device alone to meet the standard requirements of anti-scald. In order to meet the standard requirements of anti-scald, an existing deck-mount bathtub faucet needs to additionally purchase an independent thermostatic valve.

However, the existing deck-mount bathtub faucets at least have the following disadvantages.

Firstly, in order to connect the independent thermostatic valve with the bathtub faucet, additional connecting waterways are required. Therefore, the user needs to pay additional money for installing the additional thermostatic valve. The added connecting pipeline will also increase heat loss and result in the waste of energy. As a result, the user needs to pay more for the use cost.

Secondly, the flow of the bathtub faucet on the current market is generally too small, it will take a long time for injecting water in the bathtub, and the heat loss is large, which will increase the user's cost.

In addition, the added thermostatic valve can only be hidden in the bathtub or separately fixed on the surface of the bathtub, and the water temperature cannot be adjusted easily.

In view of the foregoing, what is needed, therefore, is to provide a deck-mount thermostatic bathtub faucet having the advantages of simple structure, easy to install and use.

### SUMMARY OF THE INVENTION

One object of the present application is to overcome the disadvantages in the conventional deck-mount bathtub faucet and to provide a deck-mount thermostatic bathtub faucet having the advantages of simple structure, easy to install and use.

According to one embodiment of the present invention, a deck-mount thermostatic bathtub faucet includes:

a thermostatic valve, installed on a deck, and connected with a hot water inlet, a cold water inlet and a mixed water outlet, hot water from the hot water inlet and cold water from the cold water inlet mixed in the thermostatic valve to a certain temperature and flows out of the mixed water outlet; and

a diverter valve, installed on a deck, and connected with the mixed water outlet, the diverter valve is provided with a first outlet pipe connecting with a faucet which is installed on a deck and a second outlet pipe connecting with a shower, the mixed water from the mixed water outlet into the diverter valve flowing into the faucet or the shower after being controlled by the diverter valve.

According to one aspect of the present application, the thermostat valve is installed on a deck of the bathtub and is provided with a temperature adjusting handle for adjusting the water temperature.

According to one aspect of the present application, the flow rate of the deck-mount thermostatic bathtub faucet is no less than 10 gpm at 60 psi dynamic pressure. Under the premise of meeting the requirements of installation diameter, the bathtub is set up to be filled with hot water in a shortest time, which can reduce the heat loss and save energy.

According to one aspect of the present application, the deck-mount thermostatic bathtub faucet is provided with a handheld shower fixed on an adjustable handheld holder of a shower bracket, or the deck-mount thermostatic bathtub faucet has a fixed shower with a switching valve and a handheld shower, the mixed water from the second water outlet pipe flows out of the fixed shower or the handheld shower after being controlled by the switching valve installed on the shower bracket.

According to one aspect of the present application, the diverter valve is provided with a replaceable cartridge, and the diverter valve may be provided with cartridges of different sizes. In this case, the water flow rate of the outlet can be further increased.

According to one aspect of the present application, the thermostatic valve includes a body, a thermostatic cartridge installed in the body and a rib clamped on the periphery of the thermostatic cartridge, the body has a positioning groove, and the rib has a protruding part correspondingly accommodated in the positioning groove.

According to one aspect of the present application, the body is provided with a plastic positioning sleeve surrounding the thermostatic cartridge, the bottom of the plastic positioning sleeve is provided with a positioning surface and a positioning rib, the positioning surface and the positioning rib are matched with the periphery of the thermostatic cartridge and the groove arranged on the thermostatic cartridge.

According to one aspect of the present application, the top of the plastic positioning sleeve is provided with a positioning groove, the thermostatic cartridge is provided with a temperature adjusting handle, the temperature adjusting handle is provided with a positioning convex point, and the positioning convex point can rotate within the range of the positioning groove.

According to one aspect of the present application, the top of the plastic positioning sleeve is provided with a groove, and the plastic positioning sleeve is coupled with a hand decorative cover, the hand decorative cover is provided with a positioning flange, and the positioning flange is correspondingly accommodated in the groove.

Compared with the prior art, the deck-mount thermostatic bathtub faucet of the present application has the following advantages:

Firstly, the deck-mount thermostatic bathtub faucet has an adjustable temperature thermostatic valve, which can make the outlet water temperature meet the user's requirements, save time and water that users waste when adjusting the temperature, and simplify the connecting pipelines of the products.

Secondly, the deck-mount thermostatic bathtub faucet of the present application takes the characteristics of large flow rate into account, so that the bathtub can be filled with hot water in a short time, thereby reducing the heat loss and saving energy.

More importantly, a deck-mount bathtub faucet in the United States and Canada market is required to install a temperature control device alone to meet the standard requirements of anti-scald, the deck-mount large flow thermostatic bathtub faucet of the present application has its own temperature control device, the user only need to purchase this product to meet the standard requirements and reduce the user's additional cost.

### BRIEF DESCRIPTION OF THE DRAWINGS

Implementations of the present technology will now be described, by way of example only, with reference to the attached drawings. It may be understood that these drawings are not necessarily drawn to scale, and in no way limit any changes in form and detail that may be made to the described embodiments by one skilled in the art without departing from the spirit and scope of the described embodiments.

FIG. 1 depicts a perspective of a deck-mount thermostatic bathtub faucet according to one embodiment of the present application, which is provided with a fixed shower and a handheld shower;

FIG. 2 depicts a perspective view of a deck-mount thermostatic bathtub faucet according to another embodiment of the present application, which is provided with a handheld shower only;

FIG. 3 depicts an exploded view of a deck-mount thermostatic bathtub faucet according to one embodiment of the present application;

FIG. 4 depicts a partial assembly view of a thermostatic valve shown in FIG. 3;

FIG. 5 depicts a perspective view of a plastic positioning sleeve in a thermostat valve shown in FIG. 3;

FIG. 6 depicts another partial assembly view of a thermostat valve shown in FIG. 3, wherein a plastic locating sleeve has been installed on the body;

FIG. 7 depicts yet another partial assembly view of a thermostat valve shown in FIG. 3, wherein a handle decorative cover has been installed on the body;

FIG. 8 depicts a perspective view of a thermostatic valve shown in FIG. 3, wherein a temperature adjusting handle has been installed on the thermostatic cartridge; and

FIG. 9 depicts a cross-sectional view of an assembled thermostatic valve shown in FIG. 3.

### DETAILED DESCRIPTION OF THE PREFERRING EMBODIMENTS

In order to make the purposes, technical solutions, and advantages of the present invention be clearer, the present invention will be further described in detail hereafter with reference to the accompanying drawings and embodiments. However, it will be understood by those of ordinary skill in the art that the embodiments described herein can be practiced without these specific details. In other instances, methods, procedures and components have not been described in detail so as not to obscure the related relevant feature being described. Also, it should be understood that the embodiments described herein are only intended to illustrate but not to limit the present invention.

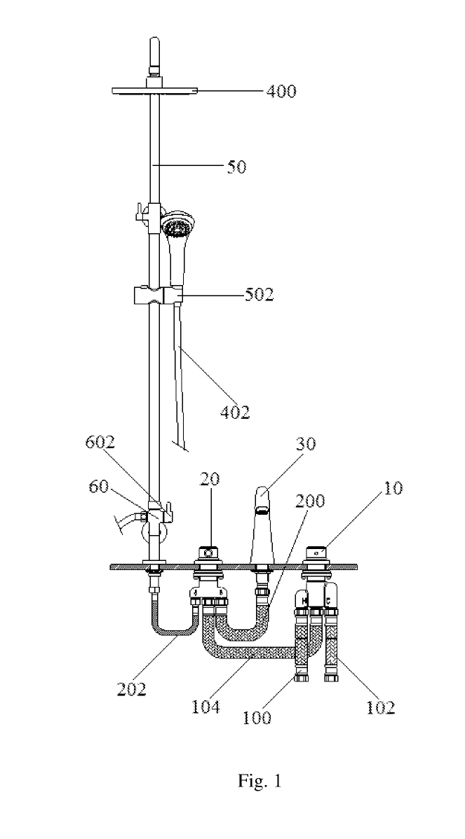

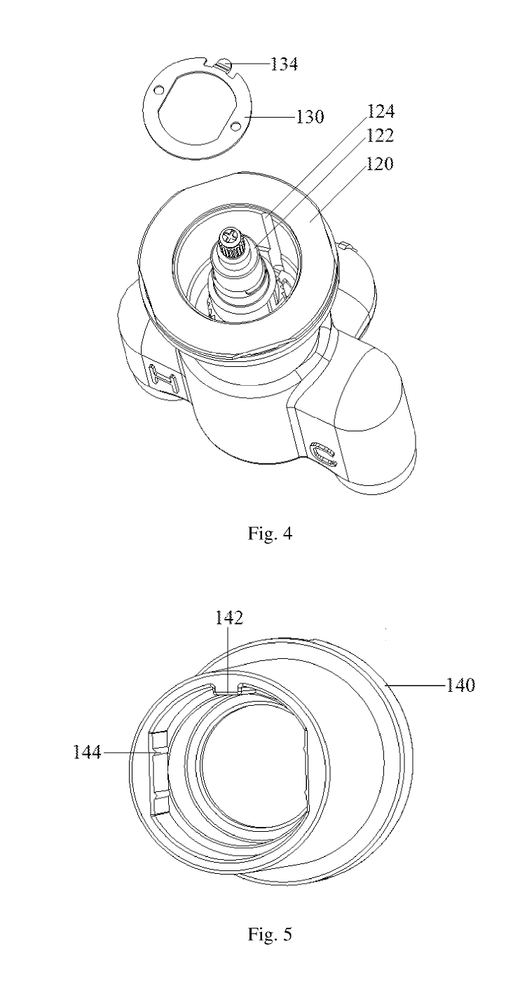

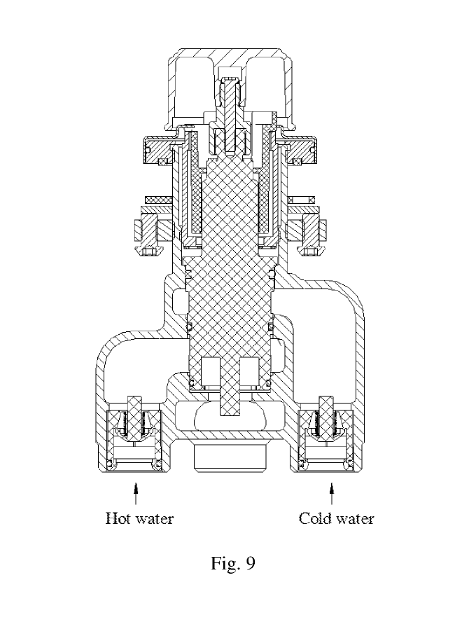

Referring to FIGS. 1 to 9, a deck-mount thermostatic bathtub faucet of the present application includes:

a thermostatic valve 10, installed on a deck and connected with a hot water inlet 100, a cold water inlet 102 and a mixed water outlet 104, hot water from the hot water inlet 100 and cold water from the cold water inlet 102 is mixed in the thermostatic valve 10 to a certain temperature and flows out of the mixed water outlet pipe 104; and

a diverter valve 20, installed on a deck and connected with the mixed water outlet 104, the diverter valve 20 is provided with a first outlet pipe 200 connecting with a faucet 30 which is installed on a deck and a second outlet pipe 202 connecting with a shower 40, the mixed water from the mixed water outlet 104 into the diverter valve 20 flows into the faucet 30 or the shower 40 after being controlled by the diverter valve 20.

The existing bathtub faucet on the market requires the installation of an ASSE 1070 or ASSE 1016 thermostatic valve after installing a Roman bath faucet. The thermostatic valve 10 of the deck-mount thermostatic bathtub faucet of the present application replaces the structure of the existing deck-mount bathtub faucet and the thermostatic valve, which can (i) save the cost of products and the installation costs; (ii) save energy and reduce the loss of heat and pressure from superfluous pipelines and equipments; (iii) easy to repair, which can be repaired on a deck.

According to one embodiment of the deck-mount thermostatic bathtub faucet of the present application, under the premise of meeting the requirements of the installation pipe diameter, the flow rate of the thermostat valve 10 is no less than 10 gpm at 60 psi dynamic pressure. At present, the flow rate of the existing bathtub faucets on the market are generally only about 6 gpm under the same condition. The deck-mount thermostatic bathtub faucet of the present application can rapidly fill the bathtub with water in a short time, reduce the time of water injection, avoid the loss of water temperature, save energy and save running costs.

Referring to FIG. 1, according to one embodiment of a deck-mount thermostatic bathtub faucet of the present invention, the shower 40 includes a fixed shower 400 and a handheld shower 402. The fixed shower 400 and the handheld shower 402 are mounted on a shower bracket 50, and the shower bracket 50 has a switching valve 60. The mixed water from the second water outlet pipe 202 flows out of the fixed shower 400 or the handheld shower 402 after being controlled by the switching valve 60. In the illustrated embodiment, the switching valve 60 is provided with a switching handle 602, the switching handle 602 has a length of no less than 2.5 inches and a maximum rotation torque of 0.55 Nm. In this case, the switching valve 60 can be actuated without exertion and the opening operation can be completed within 10 seconds, which meet the requirements of the Americans with Disabilities Act (ADA).

Referring to FIG. 1, according to one embodiment of the deck-mount thermostatic bathtub faucet of the present application, the shower bracket 50 is provided with an adjustable handheld holder 502, and the handheld shower 402 is movably installed on the shower bracket 50 through the adjustable handheld holder 502.

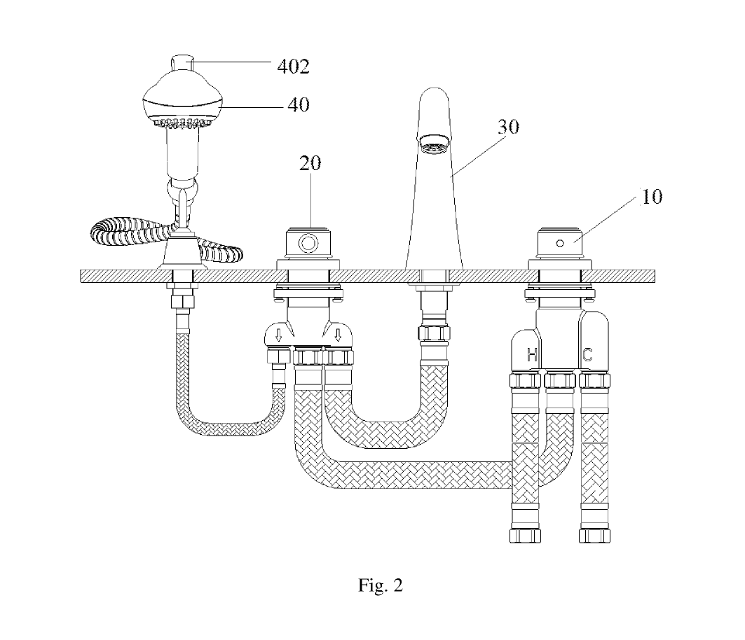

Referring to FIG. 2, according to one embodiment of the deck-mount thermostatic bathtub faucet of the present application, the handheld shower 402 is provided with a strap 404 that is available for people with no fingers, which meets the requirement of the Americans with Disabilities Act (ADA).

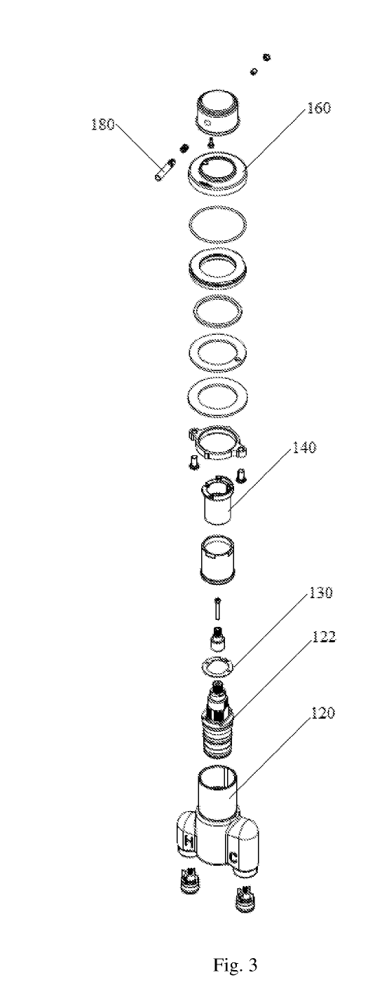

Referring to FIGS. 3 to 9, according to one embodiment of the deck-mount thermostatic bathtub faucet of the present application, the thermostatic valve 10 includes a body 120, a thermostatic cartridge 122 installed in the body 120 and a rib 130 clamped on the periphery of the thermostatic cartridge 122. The body 120 has a positioning groove 124, and the rib 130 is provided with a protruding part 134 correspondingly accommodated in the positioning groove 124.

According to one embodiment of the deck-mount thermostatic bathtub faucet of the present application, the body 120 is provided with a plastic positioning sleeve 140 surrounding the thermostatic cartridge 122, a bottom of the plastic positioning sleeve 140 is provided with a positioning surface 142 and a positioning rib 144, the positioning surface 142 and the positioning rib 144 are matched with the periphery of the thermostatic cartridge 122 and the groove arranged on the thermostatic cartridge 122.

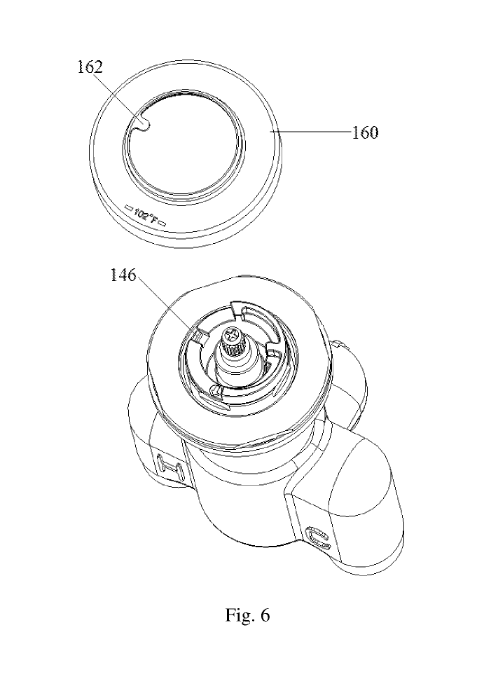

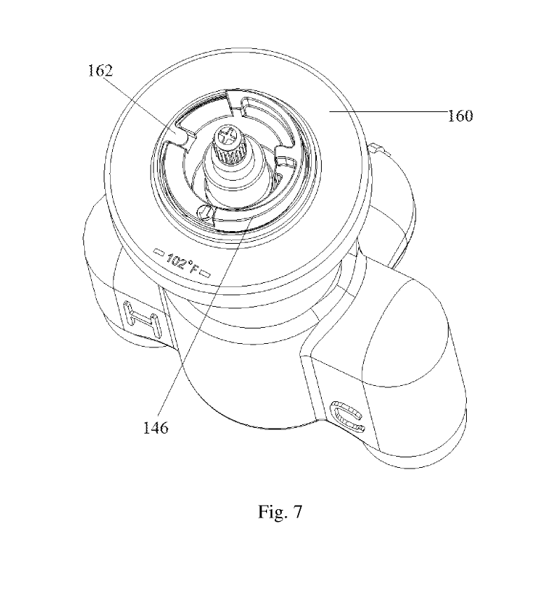

Referring to FIG. 6 and FIG. 7, according to one embodiment of the deck-mount thermostatic bathtub faucet of the present application, top of the plastic positioning sleeve 140 is provided with a groove 146, and the plastic positioning sleeve 140 is coupled with a hand decorative cover 160, the hand decorative cover 160 is provided with a positioning flange 162, and the positioning flange 162 is correspondingly accommodated in the groove 146.

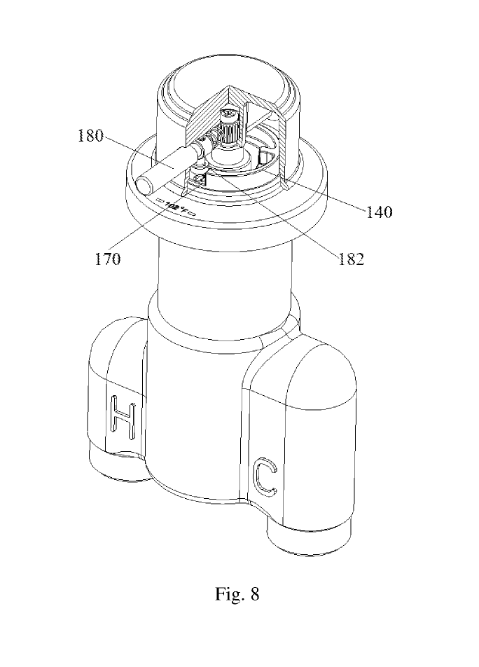

Referring to FIG. 8, according to one embodiment of the deck-mount thermostatic bathtub faucet of the present application, the top of the plastic positioning sleeve 140 is provided with a positioning groove 170 which defined by two flanges apart from each other. The thermostatic cartridge 122 is provided with a temperature adjusting handle 180. The temperature of the mixed water can be adjusted to a predetermined appropriate temperature by the temperature adjusting handle 180. The temperature adjusting handle 180 is provided with a positioning convex point 182, and the positioning convex point 182 can rotate within the range of the positioning groove 170. Matching of the positioning convex point 182 and the positioning groove 170 not only can limit the temperature of the mixed water to a desired temperature, but also can prevent the temperature adjusting handle 180 from rotating excessively to cause the thermostatic cartridge 122 to be damaged.

Compared with the prior art, the deck-mount thermostatic bathtub faucet according to the present invention has the following advantages:

Firstly, the deck-mount thermostatic bathtub faucet of the present application has an adjustable temperature thermostatic valve, which can make the temperature of the outlet water meet the user's requirements, save time and water that users waste when adjusting the temperature, and simplify the connecting pipelines of the products.

Secondly, the deck-mount thermostatic bathtub faucet of the present application takes the characteristics of large flow rate into account, so that the bathtub can be filled with hot water in a short time, thereby reducing the heat loss and saving the energy.

More importantly, the deck-mount thermostatic bathtub faucet in the United States and Canada market are all required to install a temperature control device alone to meet the standard requirements of anti-scald, the deck-mount large flow thermostatic bathtub faucet of the present application includes a temperature control device, the user only need to purchase this product to meet the standard requirements and reduce the user's additional cost.

The variation and modification of the above-described embodiments may be made by those skilled in the art to which the present invent based on the disclosure and teachings of the above specification. Therefore, the present invent is not limited to the specific embodiments disclosed and described above, modification and variation of the present invent are intended to be within the scope of the claims of the present invent. In addition, although specific terms are used in this specification, such terms are used for convenience only and are not intended to limit the invent in any way.

1. A deck-mount thermostatic bathtub faucet, comprising:
a thermostatic valve, installed on a deck and connected with a hot water inlet, a cold water inlet and a mixed water outlet, hot water from the hot water inlet and cold water from the cold water inlet being mixed in the thermostatic valve to a certain temperature and flowing out of the mixed water outlet; and
a diverter valve, installed on the deck and connected with the mixed water outlet, the diverter valve being provided with a first outlet pipe connecting with a faucet 30 which is installed on the deck and a second outlet pipe connecting with a shower, the mixed water from the mixed water outlet into the diverter valve flowing into the faucet or the shower after being controlled by the diverter valve;
wherein the diverter valve is provided with a replaceable cartridge having different sizes.

2. The deck-mount thermostatic bathtub faucet of claim 1, wherein the thermostat valve of the faucet is installed on the deck of the bathtub and is provided with a temperature adjusting handle for adjusting the water temperature.

3. The deck-mount thermostatic bathtub faucet of claim 1, wherein a flow rate of the deck-mount thermostatic bathtub faucet is no less than 10 gpm at 60 psi dynamic pressure.

4. The deck-mount thermostatic bathtub faucet of claim 1, wherein the deck-mount thermostatic bathtub faucet is provided with a handheld shower fixed on an adjustable handheld holder of a shower bracket, or the deck-mount thermostatic bathtub faucet has a fixed shower with a switching valve and a handheld shower, the mixed water from the second water outlet pipe flows out of the fixed shower or the handheld shower after being controlled by the switching valve installed on the shower bracket.

5. (canceled)

6. The deck-mount thermostatic bathtub faucet of claim 1, wherein the thermostatic valve comprises a body, a thermostatic cartridge installed in the body and a rib clamped on a periphery of the thermostatic cartridge, the body has a positioning groove, and the rib has a protruding part correspondingly accommodated in the positioning groove.

7. The deck-mount thermostatic bathtub faucet of claim 6, wherein the body is provided with a plastic positioning sleeve surrounding the thermostatic cartridge, a bottom of the plastic positioning sleeve is provided with a positioning surface and a positioning rib, and the positioning surface and the positioning rib are matched with the periphery of the thermostatic cartridge and a first groove arranged on the thermostatic cartridge.

8. The deck-mount thermostatic bathtub faucet of claim 7, wherein a top of the plastic positioning sleeve is provided with a positioning groove, the thermostatic cartridge is provided with a temperature adjusting handle, the temperature adjusting handle is provided with a positioning convex point, and the positioning convex point can rotate within the range of the positioning groove.

9. The deck-mount thermostatic bathtub faucet of claim 8, wherein the top of the plastic positioning sleeve is provided with a second groove, the plastic positioning sleeve is coupled with a hand decorative cover, the hand decorative cover is provided with a positioning flange, and the positioning flange is correspondingly accommodated in the groove.
